(19) United States
(12) Patent Application Publication
(10) Pub. No.: US 2005/0211117 A1
(43) Pub. Date: Sep. 29, 2005

(54) Inking system for flexographic printing presses

(76) Inventor: Dietmar Koopmann, Lienen (DE)

Correspondence Address: JACOBSON HOLMAN PLLC, 400 SEVENTH STREET N.W., SUITE 600, WASHINGTON, DC, 20004, US

(21) Appl. No.: 10/504,859

(22) PCT Filed: May 12, 2003
(86) PCT No.: PCT/EP03/04952

§ 371 Date: Aug. 30, 2004

(30) Foreign Application Priority Data
May 28, 2002 (DE) 102 23 66.6

(51) Int. Cl. B41F 31/30

(52) U.S. Cl. 101/216; 101/247

(57) ABSTRACT

An inking system (3) of a flexographic printing press with an anilox roller (10) and a printing plate roller (20) is shown. As a rule such inking systems contain
setting devices (11, 12, 13, 14, 15, 21, 22, 23, 24, 25)
with which (11, 12, 13, 14, 15, 21, 22, 23, 24, 25) the positions, relative to the impression cylinder (1), of these two rollers (10, 20) involved in color transport
and the positions, relative to one another, of the two rollers (10, 20) involved in color transport can be set,
by bearing blocks (15, 25), in which the axles of the two rollers (10, 20) involved in color transport are mounted, being traversed,
where the force necessary for setting the position of the two rollers (10, 20) involved in color transport is prepared,
by spindles (12, 22), which engage through nuts mounted in or on the bearing blocks (15, 25),
being turned by motors (11, 21).

It is considered as inventive that all the motors (11, 21) are mounted on the machine frame (2) on the side (turned toward the impression cylinder (1) of the two rollers (10, 20) involved in color transport.

The invention relates to the design of inking systems for flexographic printing presses. These inking systems are equipped with an anilox roller [sic] (2) and a printing plate roller [sic] (3). These two rollers are involved in the color transport during the printing process. The two aforementioned rollers carry, as a rule, sleeves which must be replaced, in particular when changing jobs.

For this purpose, the inking systems are provided with setting devices
with which the position, relative to the impression cylinder (4), of these two rollers (2, 3) involved in color transport
and the positions, relative to one another, of the two rollers (2, 3) involved in color transport can be set.

For this purpose, bearing blocks, in which the axles of the two rollers (2, 3) involved in color transport are mounted, are traversed. For this, each of the bearing blocks [of] a roller can be mounted on carriages which slide on suitable guides. There are inking systems in which the carriage of one roller slides on guides which are mounted on the carriage of the other roller. In the case of other inking systems both rollers can be traversed completely independently of one another.

The force necessary for setting the position of the two rollers involved in color transport is prepared, as a rule,
by spindles, which engage through an inner thread present in the bearing blocks,
being turned by motors.

Such a device is, for example, known from EP 0955161 A2. This publication shows an inking system in which the motors, which turn the spindles and apply the force necessary for position setting in the manner described above, are mounted on the machine frame on the side (turned away from the impression roller) of the two rollers involved in color transport.

Moreover, devices are known in which the motors which make possible the setting of the position of the printing plate roller are located on the inking system's side turned toward the impression cylinder while the motors which move the anilox roller are provided on the side (turned away from the impression cylinder) of the two rollers involved in color transport.

The positioning of the motors on the impression cylinder's side turned away from the impression cylinder, however, causes a large structural length of the inking system.

The objective of the invention thus consists of proposing an inking system design which permits a reduction of the structural length of the inking system.

This objective is realized by the fact that all the motors are mounted on the machine frame on the side (turned toward the impression roller) of the two rollers (2, 3) involved in color transport.

By machine frame any machine components suitable for fastening are to be understood. The inking system's more compact mode of construction according to the invention also leads to a reduction of the vibrations to which the rollers are subjected during the printing process. It is advantageous if the bearing block or blocks, which bear the axle of the anilox roller and the bearing block or blocks which bear the axle of the printing plate roller can be moved on different guides. In particular, guides set to different vertical positions from one another make possible a simpler positioning of the spindles in the inking system.

A particularly preferred development of the invention is characterized by the following positioning of the guides relative to the rollers:
the guides which bear the axle of one of the two rollers involved in color transport are disposed over these rollers,
while the guides which bear the axle of the other rollers involved in color transport are mounted under this roller.

In this way the motors and spindles which are assigned to the two rollers are spaced vertically in a simple manner so that their arrangement in the inking system causes no problems.

Additional embodiment examples of the invention follow from the description and the claims.

The individual figures show:

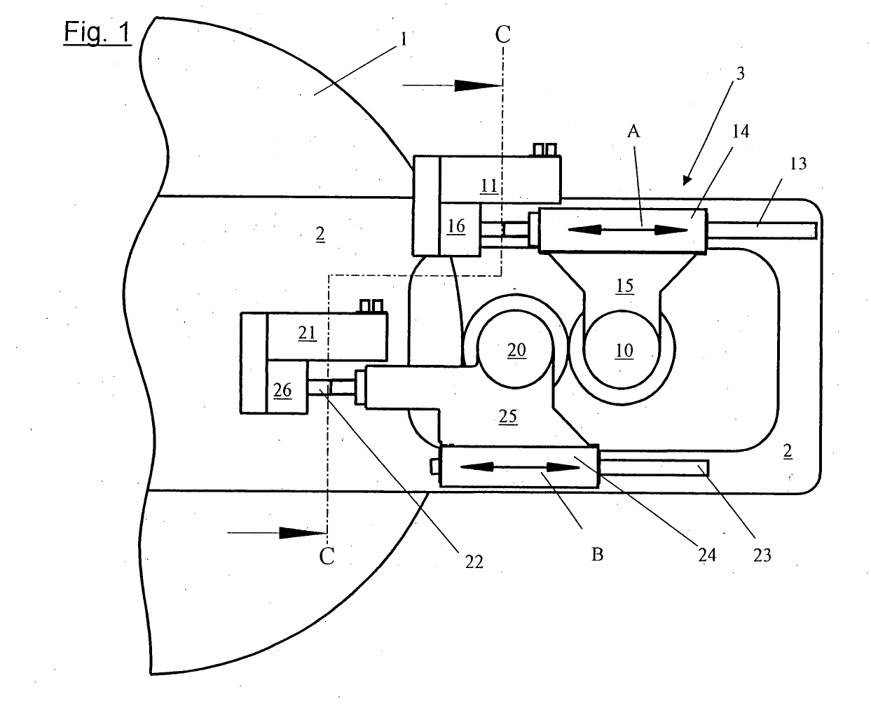

FIG. 1 a lateral view of an embodiment example of an inking system according to the invention,

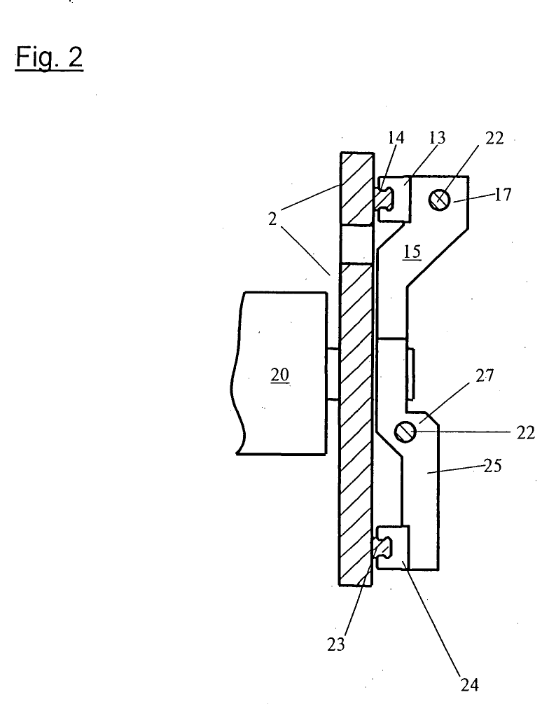

FIG. 2 a section through the inking system along the line C-C from FIG. 1.

The figures show an embodiment example of an inking system 3 according to the invention, in which inking system the positioning elements 21, 22, 23, 24, 25 assigned to the printing plate roller 20 are mounted below the printing plate roller 20 while the positioning elements 11, 12, 13, 14, 15 are disposed above the same 10. In this way the anilox roller 10, the axle-carrying bearing block 15, and the carriage 14 on which the bearing block 15 is mounted, are suspended on the bar 13. The [missing word] for movement of the carriage in the direction indicated by the arrow A is done by the motor 11 turning the spindles 12, which engage through an inner thread 17 provided in the bearing block 15. Analogously to the design of the positioning device 11, 12, 13, 14, and 15 for the anilox roller 10, the axle of the printing plate roller 20 is borne by the bearing block 25 which is mounted on the carriage 25. The carriage 25 slides in the direction predefined by the arrow B on the bar 23 if the spindle 22 is moved by the motor 21. In the embodiment example represented all the aforementioned elements of the positioning devices 11, 12, 13, 14, 15, 21, 22, 23, 24, 25 are carried by the machine frame 2. At the left edge of the picture of FIG. 1 the impression roller 1 is represented. In FIG. 1 the rollers are in the position set on the impression roller necessary for the printing process. FIG. 1 makes it clear that the free path length of the two spindles 12, 22 between the respective bearings 16, 26 of the spindles 12, 22 and the respective bearing blocks 15, 25, in this position in the devices according to the invention, can be set to be minimal.

FIG. 2 shows a section through the inking system represented in FIG. 1 along the section line C-C. This section describes, in particular the function and position of the spindle 12 and guide 13. Also the inner thread 17 and 27 in which the spindles 12 and 22 are turned and which thus have the function of unrotatable nuts are to be seen in this representation.

List of Reference Numbers

| | |
|---|---|
| 1 | Impression cylinder |
| 2 | Machine frame |
| 3 | Inking system |
| 4 | |
| 5 | |
| 10 | Anilox roller |
| 11 | Motor for the setting of the position of the anilox roller |
| 12 | Spindle for the setting of the position of the anilox roller |
| 13 | Guide for the setting of the position of the anilox roller |
| 14 | Carriage of the anilox roller |
| 15 | Bearing block for the anilox roller |
| 16 | Bearing block for the spindle 12 |
| 17 | Inner thread nut |
| 20 | Printing plate roller |
| 21 | Motor for the setting of the position of the printing plate roller |
| 22 | Spindle for the setting of the position of the printing plate roller |
| 23 | Guide for the setting of the position of the printing plate roller |
| 24 | Carriage of the printing plate roller |
| 25 | Bearing block for the printing plate roller |
| 26 | Bearing block for the spindle 22 |
| 27 | Inner thread nut |
| A | Arrow to indicate the how the anilox roller can be set |
| B | Arrow to indicate the how the printing plate roller can be set |
| C | View in FIG. 2 |

1. Inking system (3) of a flexographic printing press with an anilox roller (10) and a printing plate roller (20)
with setting devices (11, 12, 13, 14, 15, 16, 21, 22, 23, 24, 25, 26)
with which (11, 12, 13, 14, 15, 16, 21, 22, 23, 24, 25, 26) the positions, relative to the impression cylinder (1), of these two rollers (10, 20) involved in color transport
and the positions, relative to one another, of the two rollers (10, 20) involved in color transport can be set,
by bearing blocks (15, 25), in which the axles of the two rollers (10, 20) involved in color transport are mounted, being traversed,
where the force necessary for setting the position of the two rollers (10, 20) involved in color transport is prepared,
by spindles (12, 22), which engage through an inner thread (17, 27) mounted in or on the bearing blocks (15, 25),
being turned by motors (11, 21).
characterized by the fact that
all the motors (11, 21) are mounted on the machine frame (2) on the side (turned toward the impression cylinder (1) of the two rollers (10, 20) involved in color transport.

2. Inking system (3) according to claim 1
characterized by the fact that
the bearing block or blocks (15) which bear the axle of the anilox roller (10) and the bearing block or blocks (25) which bear the axle of the printing plate roller (20) can be moved on different guides (13).

3. Inking system (3) according to claim 2
characterized by the fact that
the guides (13, 23) which bear the axle of one of the two rollers (10, 20) involved in color transport are disposed over these rollers,
while the guides (13, 23) which bear the axle of the other rollers (10, 20) involved in color transport are mounted under this roller.
